(19) United States
(12) Patent Application Publication
(10) Pub. No.: US 2007/0250192 A1
(43) Pub. Date: Oct. 25, 2007

(54) AV data collector

(75) Inventors: Ming-Hui Tseng, Pingchen City (TW); Chyi-Cherng Chen, Pingchen City (TW); Chiu-Hsing Wu, Pingchen City (TW); Shin-Chuan Wang, Pingchen City (TW)

Correspondence Address: TROXELL LAW OFFICE PLLC, SUITE 1404, 5205 LEESBURG PIKE, FALLS CHURCH, VA, 22041, US

(73) Assignee: RYTEC COMPANY LIMITED.

(21) Appl. No.: 11/654,043

(22) Filed: Jan. 17, 2007

(30) Foreign Application Priority Data
Jan. 18, 2006 (TW) 095201166

(51) Int. Cl. G06F 17/00

(52) U.S. Cl. 700/94

(57) ABSTRACT

An AV data collector includes power supply unit, first read-in unit, second read in unit, control unit, memory unit, and display/play unit; audio or video data for process such video data attached to surface of an object being read first by both read-in units and then sent to the control unit where retrieves from the memory unit additional data corresponding to the data read in before transmitting the additional data to the display/play unit for displaying the video or playing the audio.

### BACKGROUND OF THE INVENTION

(a) Field of the Invention

The present invention is related to an AV (audio video) data collector, and more particularly, to one that is capable of providing additional data from audio or video data carried by an object.

(b) Description of the Prior Art

From ancient times to the present, people have been recording information on various types of objects to convey messages. For example, people print letters and drawings on books for other to access to knowledge or information by reading those books; or add colors, letters, and drawings to different locations on a surface an appliance to describe information related to that part of the appliance. Music is stored in a medium (audio tape, compact disk CD, etc.) for other to also listen to beautiful songs or rhymes with a playing device.

While we are observing an object, we frequently use our visual or hearing sense to try catching certain information. However, the form and amount of the information carried by an object are usually limited for cause of area, appearance or any other factors of the object.

Though today we may directly read from electronic system those reading data transferred into the electronic system due to advanced electronic technology; information printed on libraries and other objects are not replaceable since the paper or other graphic medium remain to present 2D (two dimension) information.

### SUMMARY OF THE INVENTION

The primary purpose of the present invention is to provide an AV data collector that provides additional data from the audio or video data carried by an object.

To achieve the purpose, the AV data collector of the present invention includes power supply unit to supply power to all units in the collector; first and second read-in units, control unit, memory unit, and display/playing unit; and the first and the second read in audio or video data to be processed and sent data to the control unit where additional data corresponding to the audio or video data are retrieved from the memory unit before transmitting the additional data to the display/playing unit to display or play the video or audio data. Accordingly, by attaching video data to the surface of an object or audio data are transmitted from the object, the video or the audio data are read by both read-in units to be processed by the AV data collector to obtain the additional data represented by the object.

### BRIEF DESCRIPTION OF THE DRAWINGS

FIG. 1 is a block chart showing a construction of the present invention.

FIG. 2 is a block chart showing a construction of a preferred embodiment of the present invention.

FIG. 3 is a schematic view showing an appearance of the construction of the present invention.

FIG. 4 is a schematic view showing an operating status of the present invention.

FIG. 5 is a schematic view showing another operating status of the present invention.

### DETAILED DESCRIPTION OF THE PREFERRED EMBODIMENTS

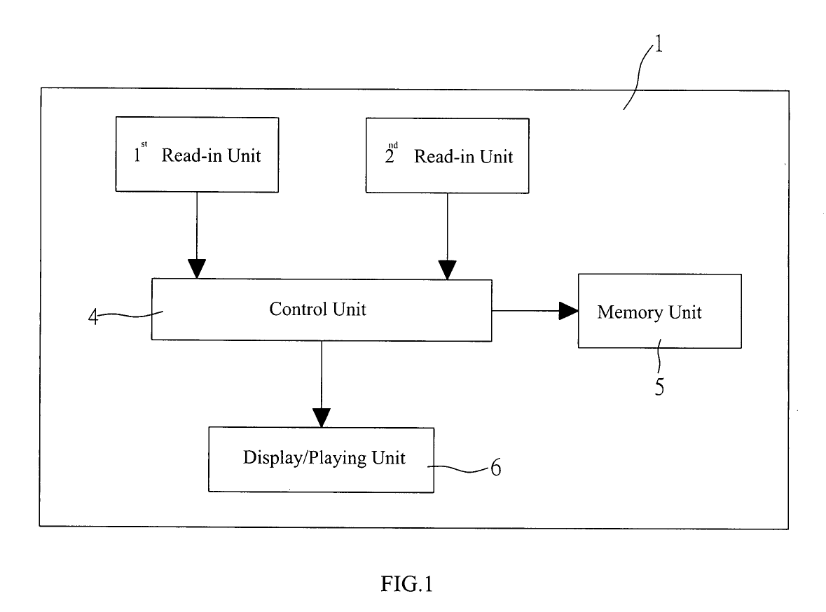

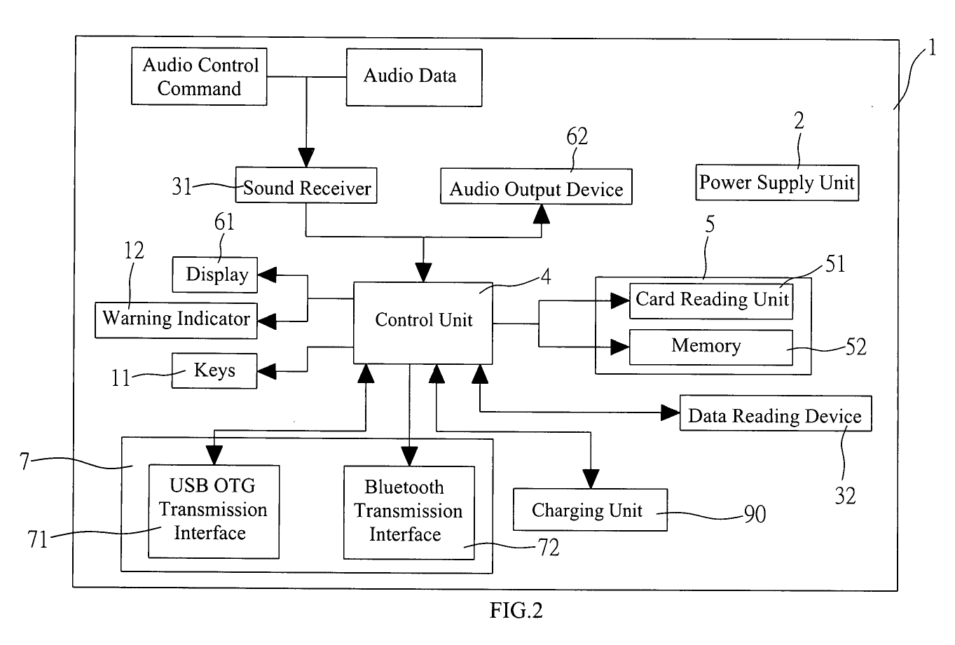

Referring to FIGS. 1 and 2 respectively for a block chart of a construction of the present invention and that of a preferred embodiment of the present invention, an AV data collector 1 of the present invention includes a power supply unit 2, a first and a second read-in unit 3, a control unit 4, a memory unit 5, a display/play unit 6. Wherein, the power supply unit 2 supplies power to each and all units in the AV data collector 1. The first and the second read-in units 3 are related to a sound receiver 31 (e.g., a microphone) and a data reading device 32. The sound receiver 31 receives audio data transmitted from an object and the data reading device 32 reads in video data attached to the object, such as 1D (one dimension), 2D array arranged bar code, video ID(Identification) bar code or RFID (Radio Frequency Identification) bar code, and transfers the audio or video data read in to the control unit 4.

The control unit 4 receives the audio or video data received by each read-in unit 3 and retrieves additional data corresponding to the audio or video data from the memory unit 5.

The memory unit 5 stores the additional data corresponding to the audio or video data. The memory unit 5 is related to a built-in memory 51 and an externally connected card reading unit 52 is provided to expand the space of the memory 51.

The display/playing unit 6 receives the additional data transmitted by the control unit 4 to display the video or play the audio. The display/playing unit 6 is related to a display 61 or an audio output device 62 (e.g., a loudspeaker) and capable of playing MPEG (Motion Picture Experts Group/II/IV, DIVX, WMV or any other video format generally used; or playing ADPCM, MP2, WMA or any other audio format generally used.

A transmission unit 7 related to wired transmission (e.g., a USB OTG transmission interface 71) or wireless transmission (e.g., a bluetooth transmission interface 72) is further provided to the AV data collector to transmit the additional data to other device for storage, or display/playing; or receive data transmitted form other device for display/playing or storage by the display 61 or the audio output device 62 (e.g., a loudspeaker), thus for the AV data collector to provide functions generally found with an MP3 player.

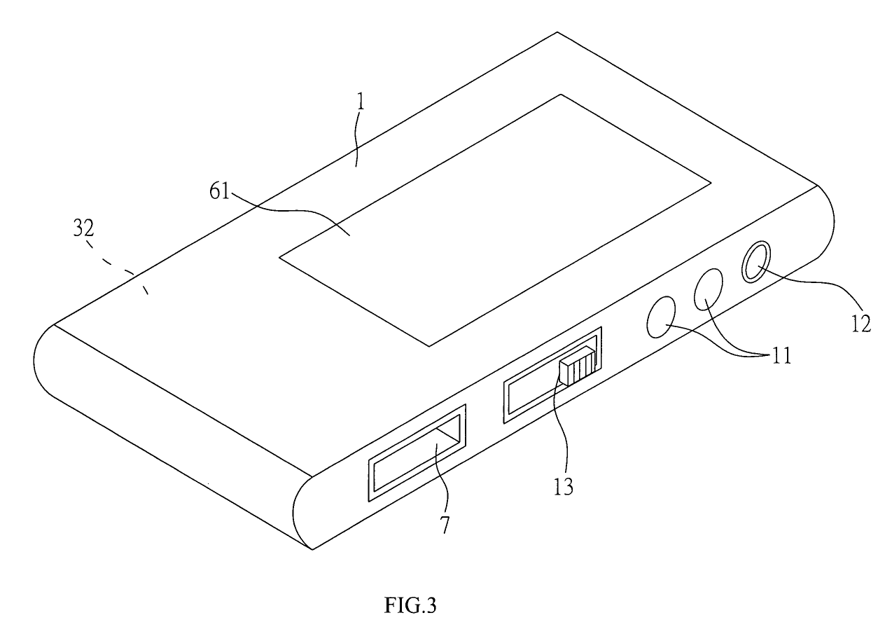

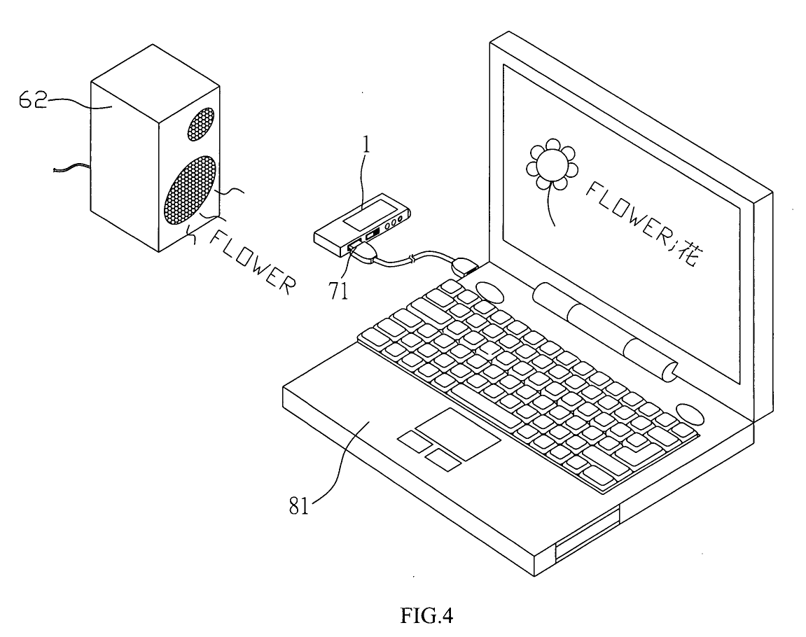

As illustrated in FIG. 3 for a schematic view of an appearance of the present invention, multiple keys 11, a warning indicator 12, and a lock-up/release key are disposed on the AV data collector 1. When the sound receiver 31 (e.g., a microphone) receives audio data from an object 81 (e.g., an externally connected speaker) or a user gives an audio command as illustrated in FIG. 2 and FIG. 4, the audio data are processed converted into electronic signals; the electronic signals are transmitted to the control unit 4 where the additional data corresponding to the audio data are retrieved from the memory unit 5 for the display 61 or the audio output device 62 (e.g., the speaker) display the video or playing the audio; or for connecting to other device, e.g., a notebook computer 82 through the USB OTG transmission interface 71. If the lock-up/release key is set to lock-up in the states of displaying video or playing audio, the user is prevented from changing the playing mode by operating the keys 11. On the contrary, if the lock-up/release key is set to lock-up and the transmission unit 7 is not receiving any data, the mode is set up for data reading.

In another preferred embodiment, when the data-reading device 32 is reading data from a bar code as illustrated in FIG. 2 and the data are converted into electronic signals and transmitted to the control unit 4 where the additional data corresponding to the data received are retrieved from the memory 5. If the memory unit 5 does not contain the additional data, the user to execute sound recording with the sound receiver 31 as desired and store the additional data in the memory unit 5 and edit by operating those multiple keys 11.

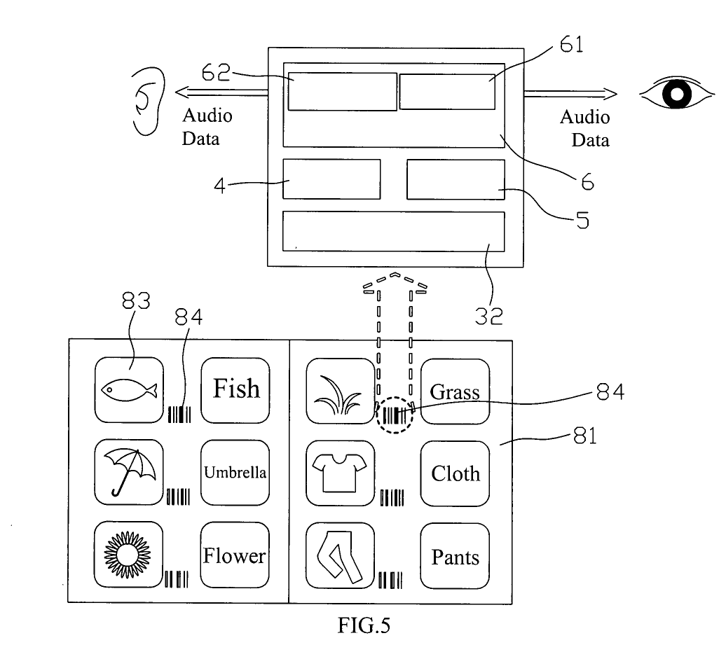

In another preferred embodiment yet of the present invention as illustrated in FIG. 5, the primary data containing multiple patterns 83 and their instructions are printed on the surface of the object 81. This type of application is usually found with inner pages of a language learning book or child teaching textbooks; and the object 81 may be made of plastic, paper or any other material that allows printing or attached with patterns and letters.

Furthermore, video data, e.g., a 2D array arranged bar code arranged 84, are provided by the side of those multiple patterns 83 for the user to read the bar code 84 through the primary data printed on those multiple patterns 83 or through the data reading device 32 of the AV data collector 1 and convert the data into electronic signals and transmit them to the control unit 4 where the additional data corresponding to the data received are retrieved from the memory unit 5. In this preferred embodiment, the additional data include video data of bird spelled in English, images of various types of bird and associate explanation and description, and audio data of bird chirps, pronunciation of “bird” in English. Wherein, the display 61 displays the video data and the audio output device 62 (e.g., a loudspeaker) plays the audio data.

As illustrated in FIGS. 2 and 3, a charging unit 90 is further provided to the AV data collector 1 to execute charging by the transmission unit 7 when the lock-up/release key is set in the status of lock-up. Each of those multiple keys 11 is assigned with a specific function command. For example, operating those keys 11 commands the display 61 or the audio output device 62 to execute the function of display of playing. An operation description file is pre-stored in the memory unit 5 so that it is play in real time during the operation for the user to learn how to operate the AV data collector. Those keys 11 can also be operated to control the playing mode of the audio data (including normal, single song, all songs, play at random, repeat, and browse) and audio field mode (including normal, jazz, rock & roll, classic, and popular) to improve the industrial applicability of the AV data collector. Of course, other than the operation description file, an operation code page may be further provided to pre-edit various bar codes to designate specific function to the AC data collector 1 upon having read in the data. For example, a specific bar code is read in to have the AV data collector to execute only the read-only and play status, or other bar code is read in to have the AV collector to control play or audio field mode of the audio data.

The prevent invention provides an improved structure of an improved structure of an AV data collector, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim,

1. An AV data collector including a power supply unit supplying power to each and all units including in the AV data collector; a first read-in unit and a second read-in unit reading audio or video data to be processed and transmitting the data to a control unit; a memory unit storing additional data corresponding to the audio or video data; the control unit receiving the audio or video data from each read-in unit and retrieving the additional data corresponding to the audio or video data from the memory unit; and a display/playing unit receiving the additional data transmitted from the control unit to display the video or playing the audio.

2. The AV data collector as claimed in claim 1, wherein the first read-in unit is a sound receiver.

3. The AV data collector as claimed in claim 1, wherein the second read-in unit is a data reading device.

4. The AV data collector as claimed in claim 1, wherein the memory unit is a built-in memory;
and the memory space is expanded by means of an externally connected card-reading unit.

5. The AV data collector as claimed in claim 1, wherein the display/playing unit is a display or an audio output device.

6. The AV data collector as claimed in claim 1, wherein the video data read by the secondread-in unit are related to 1D, 2D, 2D array arranged bar code, video ID bar code or RFID bar code.

7. The AV data collector as claimed in claim 1, wherein the display/playing is capable of playing ADPCM, MPS, WMA or any other audio format generally used.

8. The AV data collector as claimed in claim 1, wherein the display/playing is capable of playing MPEG/II/IV, DIVX, WMV or any video formats generally used.

9. The AV data collector as claimed in claim 1, wherein an operation file is stored in the memory unit to play the operation file during the operation of the AV data collector.

10. The AV data collector as claimed in claim 1, wherein the AV data collector is further provided with a transmission unit.

11. The AV data collector as claimed in claim 10, wherein the transmission unit is capable of executing wired or wireless transmission.

12. The AV data collector as claimed in claim 11, wherein the wired transmission is related to a USB OTG transmission interface.

13. The AV data collector as claimed in claim 11, wherein the wireless transmission relates to a bluetooth transmission interface.

14. The AV data collector as claimed in claim 1, wherein the AV data collector is further provided with a charging unit.

15. The AV data collector as claimed in claim 1, wherein the AV data collector is provided with multiple keys, a warning indicator, and a lock-up/release key.

16. The AV data collector as claimed in claim 1, wherein the AV data collector is further provided with a page of operation bar code;
various bar codes are pre-edited for the AV data collector to provide different specific functions after data are read by the first and the second read-in units.
